(19) United States
(12) Patent Application Publication
(10) Pub. No.: US 2014/0229832 A1
(43) Pub. Date: Aug. 14, 2014

(54) MEDIA FILE USER INTERFACE

(71) Applicant: Qualcomm Innovation Center, Inc., San Diego, CA (US)

(72) Inventors: Pierre-Antoine B. LaFayette, Scarborough (CA); Denise Cheng, Markham (CA)

(73) Assignee: Qualcomm Innovation Center, Inc., San Diego, CA (US)

(21) Appl. No.: 13/766,643

(22) Filed: Feb. 13, 2013

(51) Int. Cl. G06F 3/048

(52) U.S. Cl. CPC G06F 3/048
USPC 715/719

(57) ABSTRACT

A computing device comprising storage for at least one media file comprising plurality of images associated with one or more timestamps and a display for a media file user interface comprising at least one adjustable numeric time display. The at least one adjustable numeric time display is adapted to receive a time associated with the one or more timestamps and is further adapted to display at least one of the plurality of images associated with the time.

### BACKGROUND OF THE INVENTION

1. Field of the Invention

This invention is related to a computing device media user interface. Specifically, but not intended to limit the invention, embodiments of the invention are related to a user interface which enables a user to initiate playback of a time-based media file at a specified user-supplied media file time.

2. Relevant Background

On many computing devices, a media file user interface may allow a user to access a location within a time-based media file by allowing the user to select a geographic location within the user interface. However, it is often difficult to access a desired part of the media file though such actions. For instance, the media file user interface geographic location may comprise a size where it is difficult for a user to select a particular part of the user interface that is associated with a particular portion of the media file that is desired to be viewed. Oftentimes, a user repeatedly selects various geographic locations on the user interface to access the desired media file location.

### SUMMARY OF THE INVENTION

In order to provide a user the ability to quickly, effectively, and easily access a desired location within a media file, a system, device, method, and storage medium were created to provide an improved a media file user interface.

One embodiment of such an invention comprises a computing device having a storage for at least one media file and a display for a media file user interface comprising at least one adjustable numeric time display. The media files comprises a plurality of images associated with one or more timestamps while the media file user interface comprises at least one adjustable numeric time display adapted to receive a time associated with the one or more timestamps and display at least one of the plurality of images associated with the time.

Another embodiment of the invention comprises a method of accessing a desired portion of a time-based media file. The method may comprise accessing the time-based media file through a time-based media file user interface and selecting an adjustable numeric time display in the user interface. The method may further comprise modifying the adjustable numeric time display from a first numerically displayed time to a second numerically displayed time and playing the time-based media file beginning at the second numerically displayed time.

And another embodiment of the invention comprises a computing system. The computing system comprises a means for accessing the time-based media file through a time-based media file user interface. The computing system further comprises a means for selecting an adjustable numeric time display in the user interface. The computing system yet further comprises a means for modifying the adjustable numeric time display from a first numerically displayed time to a second numerically displayed time. And the computing system yet still further comprises a means for playing the time-based media file beginning at the second numerically displayed time.

Yet another embodiment of the invention comprises a non-transitory, tangible computer readable storage medium, encoded with processor readable instructions to perform a method of accessing a desired portion of a time-based media file. The method comprises displaying a time-based media file user interface. The method further comprises accessing the time-based media file through the time-based media file user interface. The method now further comprises modifying an adjustable numeric time display within the time-based media file user interface from a first numerically displayed time to a second numerically displayed time. The method yet further comprises playing the time-based media file beginning at the second numerically displayed time.

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

### BRIEF DESCRIPTION ON THE DRAWINGS

FIG. 1 illustrates a computing device according to one embodiment of the invention;

FIG. 2 illustrates an adjustable numeric time display according to one embodiment of the invention;

FIG. 3 illustrates a flowchart that depicts a method that may be carried out in connection with the embodiments described herein;

FIG. 4 illustrates a block diagram depicting components of a computing device;

FIG. 5A comprises an adjustable numeric time according to one embodiment of the invention; and

FIG. 5B comprises an adjustable numeric time according to one embodiment of the invention.

### DETAILED DESCRIPTION

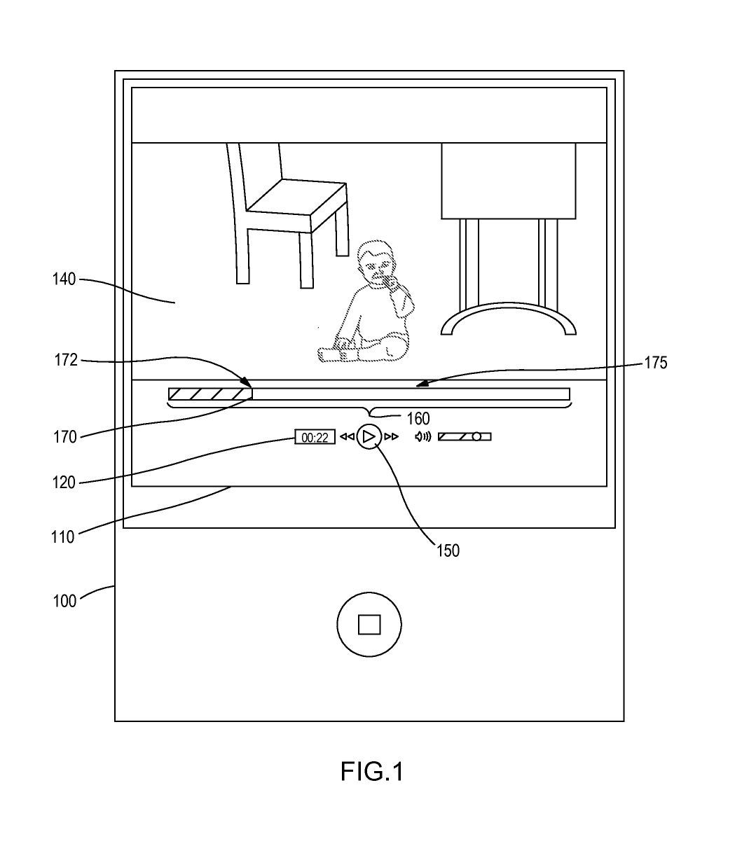

Turning first to FIG. 1, seen is a computing device 100 comprising a media file user interface 110. The computing device 100 seen in FIG. 1 is a mobile computing device. Desktop, tablet, and other types of computing devices 100 known in the art are also contemplated. One media file user interface 110 comprises at least one adjustable numeric time display 120. In one embodiment, the at least one adjustable numeric time display 120 may comprise a plurality of adjustable numeric time displays 120. Furthermore, although the at least one numeric time display 120 in FIG. 1 is shown as minutes and seconds, it is contemplated that the at least one numeric time display 120 may comprise additional time increments such as, but not limited to, one or more seconds decimal increments. It is further contemplated that the at least one numeric time display 120 may comprise a different display design than that as seen in FIG. 1. For example, the at least one numeric time display 120 may comprise a clock face.

A user may access the at least one numeric time display 120 my clicking the at least one numeric time display 120 through the use of a mouse or through touching the at least one numeric time display 120 on a touchscreen. Other access methods and devices known in the art are also contemplated. Where the at least one numeric time display 120 comprises, for example, a clock face, a user may click or otherwise access a desired hour on the clock face.

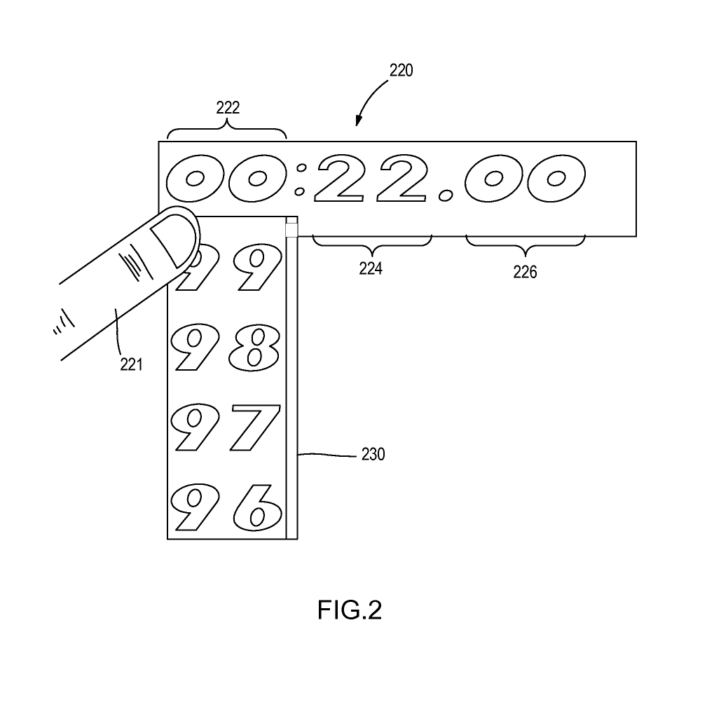

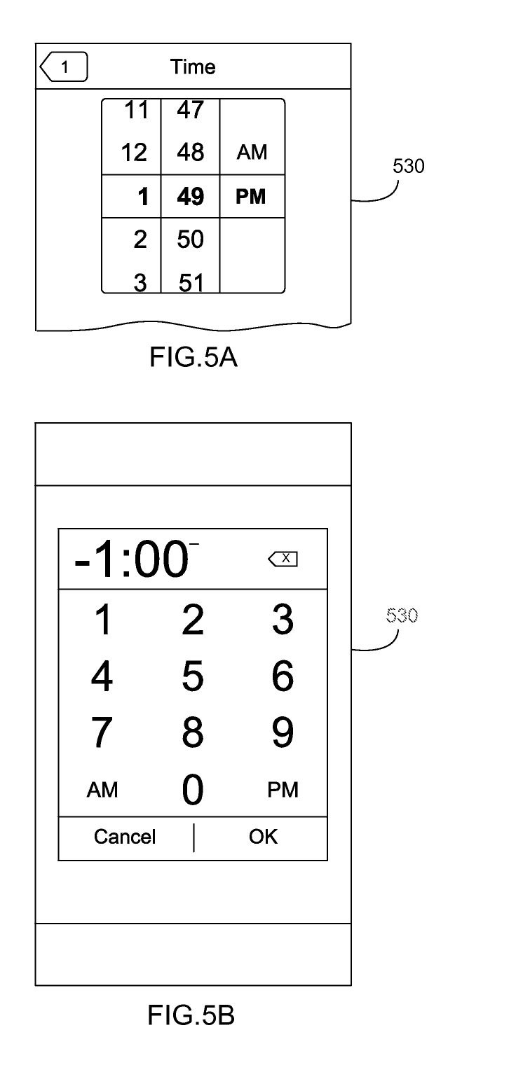

Turning now to FIG. 2, seen is one example of an at least one adjustable numeric time display 220 upon being accessed by a user. For example, a user may access the numeric time display 220 displayed on a computing device touchscreen by touching one of the minutes portion 222, seconds portion 224 or decimal portion 226 of the display 220 with a finger 221 or other touching device. Other display portions such as, but not limited to, an hour portion or additional decimal portions are contemplated. Upon accessing one of the portions of the display 220, a time-selection user interface 230 such as, but not limited to, the time-selection user interface 230 seen in FIG. 2 may be displayed. Although the time-selection user interface 230 in FIG. 2 only shows the minutes portion 222 of the display 220, it is contemplated that one or more additional portions may also be displayed. Alternatively, upon accessing the display 220, a blinking cursor may be displayed in the minute portion 222 or any other portion of the display 220, or the user may be otherwise alerted that the display may be modified through textual input by the user. Therefore, the adjustable display may comprise a data entry reception area adapted to receive data upon selection by a user. Looking at FIGS. 5A and 5B, seen are other examples of a time-selection user interface 530.

Upon accessing the display 220, a user may enter a desired time in the display 220. For example, upon launching a video 140 such as, but not limited to, the video 140 displayed in FIG. 1, a user may wish to view a specific scene within the video 140. In order to do so, the user may enter the start-time of the video scene into the display 120 by typing the desired scene start time directly into the display 220. Upon entering the start-time of the scene, a user may display the scene by, for example, pressing a user interface play button 150 on the user interface 110. Alternatively, any other portion of the user interface 110 may be accessed by the user to initiate playing the video 140 at the desired start time or, a user may depress a keyboard key to initiate playing the video 140 at the desired time. Therefore, it is contemplated that the numeric time display 120 comprises a real-time time display of the time associated with the video 140 currently being displayed. The video timestamp associated with the time being shown in the display 220 may be referred to as an active timestamp or an active one of the one or more media timestamps. Therefore, the term “active” may refer to the timestamp in the media file associated with a presently-displayed video image on the user interface 110.

Upon entering a desired start time of the video 140 associated with the display 220 and performing a function to initiate playing of the video at the desired start time, the user interface 110 may begin to play the video 140 at the desired start time by accessing one or more timestamps in the media file comprising the video 140. In one embodiment, the user interface 140 may determine which media file timestamp is most closely associated with the entered time and then display the video image associated with that timestamp.

In one embodiment, it is contemplated that upon launching the user interface 110, the video 140 may begin to play by displaying the video associated with a first timestamp and subsequently display each sequentially successive timestamp. As the user interface 110 displays the video 140 associated with each sequentially successive timestamp, the numeric time display 120 changes to also display the time associated with the timestamp associated with the video being displayed. In one embodiment, the numeric time display 120 may comprise an end time so that a user knows the length of time that the video 140 will run for. Upon accessing the numeric time display 120, the video may pause, and/or the numeric time display 120 may pause, though the video may continue to display successive video images. An embodiment is also contemplated where the numeric time display 120 does not pause after accessing the display 120.

In any event, upon modifying the display 120 to a desired time and requesting to access the video at that time, the numeric time display 120 will change from a first numerically displayed time to a second numerically displayed time. The first numerically display time may comprise the paused time shown in the numeric time display 120 prior to entering the desired time, or may comprise the time associated with the timestamp of the last video image displayed in the user interface 110 prior to the video 140 changing to the desired video time. The second numerically displayed time may comprise the desired entered video time. The first numerically displayed time may be associated with a first of the one more media timestamps and the second numerically displayed time is associated with a second of the one or more media timestamps. The first numerically displayed time may be different from the second numerically displayed time and therefore, the first of the one or more media timestamps may be different than the second of the one or more media timestamps.

As seen in FIG. 1 the user interface 110 may comprise at least one geographical reception area 160 where each portion of the geographical reception area may be associated with at least one media file timestamp. The geographical reception area 160 seen in FIG. 1 may comprise a time-bar. However, other geographical receptions areas are contemplated such as, but not limited to, a clock-face geographical reception area. The location of an identifier 170 in the at least one geographical reception area 160 may be associated with the time display 120 and with the one or more timestamps that are associated with the time shown in the time display 120. Therefore, modification of the adjustable numeric time display 120 from the first numerically displayed time to the second numerically displayed time may adjust the identifier 170 from a first identifier location to a second identifier location. In one such example, the first numerically displayed time may comprise the time seen in FIG. 1 of 00:22, with the location of the identifier in the time-bar being associated with the 00:22 s. The second numerically displayed time, which may comprise the entered time by the user may be a time of 00:50 s. In such an example, the identifier 170 may move from the first identifier location 172 to a new geographic location within the geographic reception area 160 associated with the timestamp for 00:50 s. Such a location may comprise the second identifier location 175 seen in FIG. 1 The first identifier location 172 may be associated with the first of the one more media timestamps and the second identifier location being associated with a second the one more media timestamps.

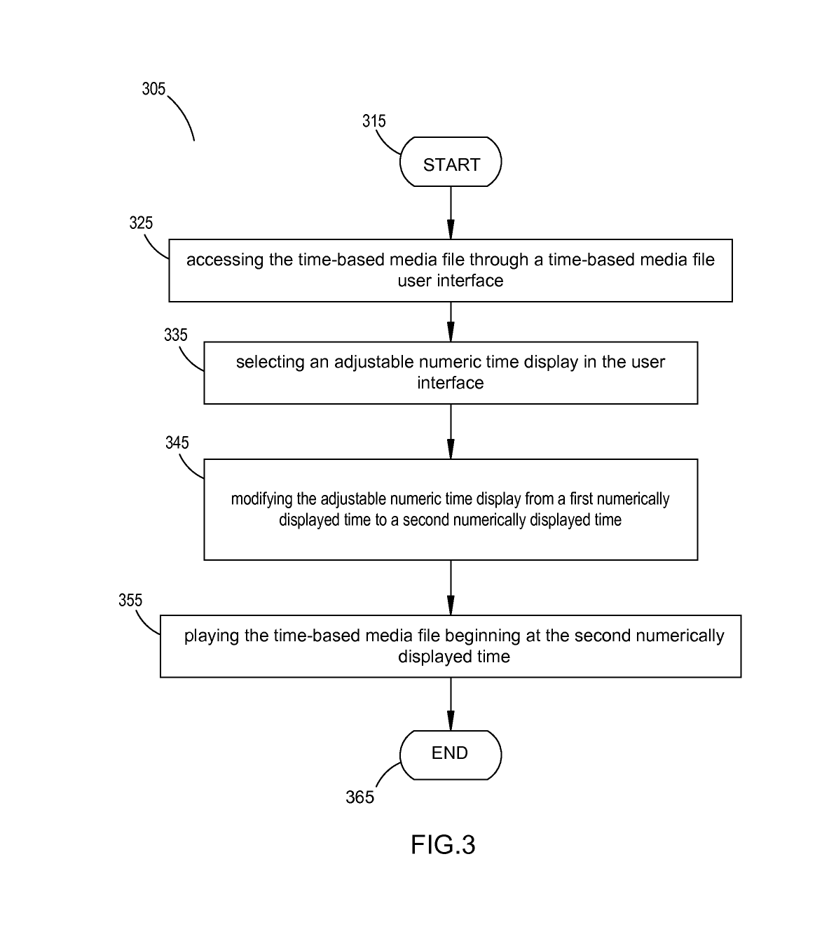

Turning now to FIG. 3, seen is a method 305 of accessing a desired portion of a time-based media file. One type of time-based media file may comprise the media file discussed above with respect to FIGS. 1 and 2, such as, but not limited to, a video or an audio file. However, other types of media files are also contemplated such as an audio/video file having textual and/or internet-based information, and/or other types of multimedia files. One such method 305 starts at 315 and at 325 comprises accessing the time-based media file through a time-based media file user interface. One such user interface may comprise the user interface 110 described above with respect the FIG. 1. At 335 the method 305 comprises selecting an adjustable numeric time display in the user interface. One adjustable numeric time display comprises the display 120, 220 seen in FIGS. 1 and 2. At 345 the method 305 comprises modifying the adjustable numeric time display from a first numerically displayed time to a second numerically displayed time. The first numerically displayed time may comprise a time of 00:00.00, which may be automatically displayed on the user interface upon launching of a media file and prior to activating a play button 150 on the user interface 110. One second numerically displayed time may comprise an entered time of 00:22.00, which may be a start time for a scene a user wishes to view. At 355 the method may comprise playing the time-based media file beginning at the second numerically displayed time. For instance, upon entering the second numerically displayed time in the adjustable numeric time display, the media file may start to play at the second numerically displayed time.

In one method 305, modifying the adjustable numeric time display 220 may comprise accessing a time-selection user interface such as, but not limited to, the time-selection user interface 230 seen in FIG. 2. The method 305 may further comprise associating the second numerically displayed time with a time-based media file timestamp. For example, upon entering the second numerically displayed time within the adjustable numeric time display 220, the user interface 110 may operatively access the media file and determine a media file timestamp associated with the second numerically displayed time. In one embodiment, the second numerically displayed time may be entered an increment of time in proportional to a media file timestamp time increment. For example, each media file timestamp may comprise a time increment of about 0.01 s. In such a case, the second numerically displayed time may be entered into the adjustable numeric time display with a smallest increment of time being 0.01 s. Other time increments are contemplated.

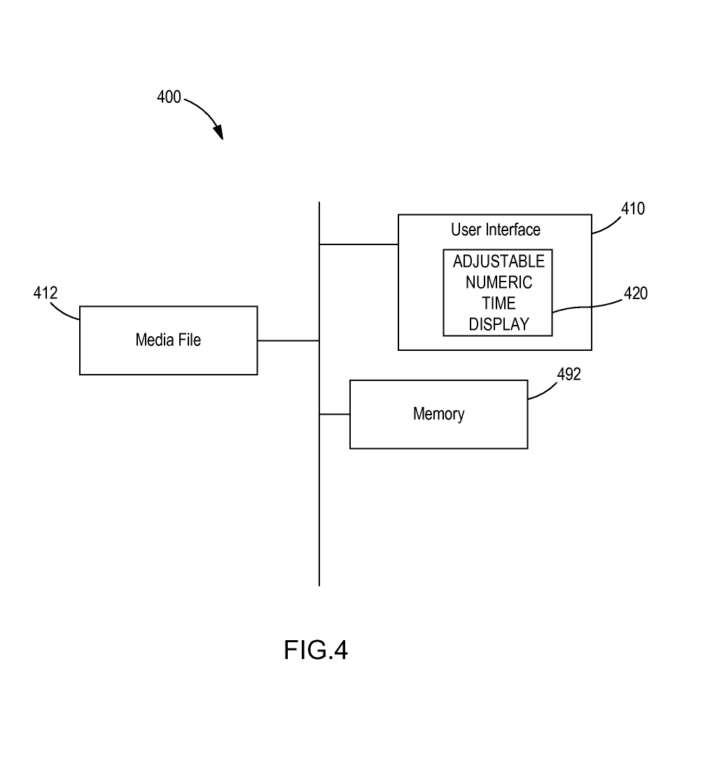

Turning now to FIG. 4, seen is one embodiment of the invention comprising a computing system 490. One computing system 490 comprises a means for accessing a time-based media file 412 through a time-based media file user interface 410. One time-based media file may comprise a video or audio file, may be stored on a computing device memory and may be accessed through the use of one or more processing devices. The user interface may also be stored on a computing device memory. The time-based media file user interface 410 may comprise the user interface 110 described above in FIG. 1.

The system 490 may also comprise a means for selecting an adjustable numeric time display 420, which may comprise a portion of the user interface 412. Selecting an adjustable numeric time display 420 in the user interface 412 may comprise stopping the time display 420 from moving through a plurality of media file timestamps. For example, the media file 412 may be playing within the user interface 410 by accessing a plurality of media file timestamps and displaying the image and/or emitting the audio associated with the timestamp. In one embodiment, the sound emitted may comprise a standard beep as a feedback to the user that a new time has been set, rather than playing the actual audio at that point in the stream. In one embodiment, the image and/or audio associated with each successive timestamp may displayed/emitted. As such, in selecting the numeric time display 420 in the user interface 412, the time display 420 may cease to access the timestamps and therefore may cease to display/emit the video/audio file associated with the timestamps. Selecting the adjustable numeric time display 420 may enable to display 420 for modification. The system 490 may also comprise a means for modifying the adjustable numeric time display 420 from a first numerically displayed time to a second numerically displayed time. For example, the time-selection user interface 230 seen in FIG. 2 and described above may be used to modify the display 420. The first numerically displayed time may comprise a time not associated with any of the plurality of media file timestamps. For example, the user interface 410 may be adapted to display a first numerically displayed time may comprise a time of 00:00.00.

The system 490 may further comprise a means for playing the time-based media file. For example, the user interface 410 may comprise the play button 150 seen in FIG. 1. In one embodiment, upon entering the second numerically displayed time, the play button 150 may be pressed and the media file 412 may be played, beginning at the second numerically displayed time. Furthermore, the means for playing the time-based media file 412 beginning at the second numerically displayed time may comprise accessing one of the plurality of media file timestamps, with the one of the media file timestamps comprising a timestamp associated with the second numerically displayed time. The means for playing the time-based media file 412 beginning at the second numerically displayed time may further comprise at least one of displaying video associated with the timestamp associated with the second numerically displayed time, and emitting audio associated with the timestamp associated with the second numerically displayed time.

Another embodiment of the invention may comprise non-transitory, tangible computer readable storage medium, encoded with processor readable instructions to perform a method of accessing a desired portion of a time-based media file. Such an embodiment may be communicatively stored on a computing device memory 492, as seen in FIG. 4. In one embodiment, the method of accessing a desired portion of a time-based media file 412 comprises displaying a time-based media file user interface 410, accessing the time-based media file 412 through the time-based media file user interface 410, modifying an adjustable numeric time display 420 within the time-based media file user interface 410 from a first numerically displayed time to a second numerically displayed time, and playing the time-based media file 412 beginning at the second numerically displayed time. The term “time-based media file” refers to any file comprising a time element such as, but not limited to, a timestamp. It is contemplated that the memory 492 may also be referred to herein as a storage and that the memory 492 may be used to store the time-based media file, which may also be referred to as an at least one media file.

In one embodiment, modifying an adjustable numeric time display 420 such as, but not limited to the display 220 seen in FIG. 2, within the time-based media file user interface 410 from a first numerically displayed time to a second numerically displayed time may comprise identifying a one or more portions of the media file 412 to access, providing a user with a media file time associated with the one or more portions of the media file, and one of inputting and selecting the media file time associated with the one or more portions of the media file. In one embodiment identifying a one or more portions of the media file 412 to access comprises at least one of, selecting one or more scenes from a video file and choosing to hear one or more portions of an audio file.

In conclusion, embodiments of the present invention provide for methods, devices, and apparatus related to a media file user interface. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A computing device comprising, storage for at least one media file comprising a plurality of images associated with one or more timestamps; and
a display for a media file user interface comprising at least one adjustable numeric time display adapted to,
receive a time associated with the one or more timestamps, and
display at least one of the plurality of images associated with the time.

2. The computing device of claim 1 wherein,
the media file further comprises a plurality of sounds associated with the one or more timestamps; and
the media file user interface is further adapted to emit at least one of the plurality of sounds associated with the time.

3. The computing device of claim 1 wherein, the adjustable numeric time display is further adapted to display a first numerically displayed time.

4. The computing device of claim 3 wherein,
the time comprises a second numerically displayed time;
the adjustable numeric time display is further adapted for modification from the first numerically displayed time to the second numerically displayed time.

5. The computing device of claim 4 wherein,
the first numerically displayed time is associated with a first of the one more media timestamps;
the second numerically displayed time is associated with a second of the one or more media timestamps;
the first numerically displayed time is different from the second numerically displayed time; and
the first of the one or more media timestamps is different than the second of the one or more media timestamps.

6. The computing device of claim 1 wherein the adjustable numeric time display comprises a data entry reception area adapted to receive data upon selection by a user.

7. The computing device of claim 2 wherein,
the at least one of the plurality of images and the at least one of the plurality of sounds comprises one of a real-time,
display of an image, and
emitting of a sound; and
the one of a real-time time display of an image and emitting of a sound is associated with an active one of the one or more media timestamps.

8. The computing device of claim 7 wherein,
the media file user interface is further adapted to display a video; and
the active one of the one or more media timestamps comprises a timestamp associated with a presently-displayed video image.

9. The computing device of claim 5 wherein, the media file user interface further comprises at least one geographical reception area.

10. The computing device of claim 9 further comprising,
an identifier in the at least one geographical reception area, the identifier being associated with the at least one adjustable numeric time display; wherein,
one or more portions of the at least one geographical reception area is associated with at least one of the one or more media file timestamps; and
modification from the first numerically displayed time to the second numerically displayed time adjusts the identifier from a first identifier location to a second identifier location, the first identifier location being associated with the first of the one more media timestamps and the second identifier location being associated with the second of the one more media timestamps.

11. A method of accessing a desired portion of a time-based media file, the method comprising,
accessing the time-based media file through a time-based media file user interface;
selecting an adjustable numeric time display in the user interface;
modifying the adjustable numeric time display from a first numerically displayed time to a second numerically displayed time; and
playing the time-based media file beginning at the second numerically displayed time.

12. The method of claim 9 wherein, modifying the adjustable numeric time display comprises accessing a time-selection user interface.

13. The method of claim 9 further comprising, associating the second numerically displayed time with a time-based media file timestamp.

14. The method of claim 9 wherein, an increment of time in the second numerically displayed time is proportional to a media file timestamp time increment.

15. The method of claim 12 wherein, the increment of time in the second numerically displayed time comprises the smallest increment of time.

16. A computing system comprising,
means for accessing the time-based media file through a time-based media file user interface;
means for selecting an adjustable numeric time display in the user interface;
means for modifying the adjustable numeric time display from a first numerically displayed time to a second numerically displayed time; and
means for playing the time-based media file beginning at the second numerically displayed time.

17. The computing system of claim 14 wherein, a means for accessing the time-based media file through a time-based media file user interface comprises accessing at least one of a video file and an audio file through the user interface.

18. The computing system of claim 14 wherein, a means for selecting an adjustable numeric time display in the user interface comprises stopping the time display from moving through a plurality of media file timestamps.

19. The computing system of claim 16 wherein,
the first numerically displayed time comprises a time not associated with any of the plurality of media file timestamps; and
the means for playing the time-based media file beginning at the second numerically displayed time comprises,
accessing one of the plurality of media file timestamps, the one of the media file timestamps comprising a timestamp associated with the second numerically displayed time, and at least one of,
displaying video associated with the second numerically displayed time timestamp, and
emitting audio associated with the second numerically displayed time timestamp.

20. A non-transitory, tangible computer readable storage medium, encoded with processor readable instructions to perform a method of accessing a desired portion of a time-based media file comprising,
displaying a time-based media file user interface;
accessing the time-based media file through the time-based media file user interface;
modifying an adjustable numeric time display within the time-based media file user interface from a first numerically displayed time to a second numerically displayed time; and
playing the time-based media file beginning at the second numerically displayed time.

21. The non-transitory, tangible computer readable storage medium of claim 18 wherein, modifying an adjustable numeric time display within the time-based media file user interface from a first numerically displayed time to a second numerically displayed time comprises,
identifying a one or more portions of the media file to access; and
providing a user with a media file time associated with the one or more portions of the media file; and
one of inputting and selecting the media file time associated with the one or more portions of the media file.

22. The non-transitory, tangible computer readable storage medium of claim 19 wherein, identifying a desire to access one or more portions of the media file comprises at least one of,
selecting one or more scenes from a video file; and
choosing to hear one or more portions of an audio file.
